(19) United States
(12) Patent Application Publication
(10) Pub. No.: US 2008/0081005 A1
(43) Pub. Date: Apr. 3, 2008

(54) CHEMICAL SYNTHESIS DEVICE

(76) Inventors: Mio SUZUKI, Hitachinaka (JP); Shigenori TOGASHI, Abiko (JP); Tetsuro MIYAMOTO, Kasumigaura (JP); Tadashi SANO, Ushiku (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/835,457

(22) Filed: Aug. 8, 2007

(30) Foreign Application Priority Data
Sep. 29, 2006 (JP) 2006-266252

(51) Int. Cl. G05D 7/00

(52) U.S. Cl. 422/105

(57) ABSTRACT

An object of the present invention is to increase the volume of production even with the use of a microreactor, and to improve the quality of reaction products. A chemical synthesis device with a microreactor having a microchannel includes a plurality of microreactors arranged in parallel; a raw material tank that stores a raw material; a pump that delivers the raw material; an inlet solenoid valve and an outlet solenoid valve disposed at the inlet and outlet sides, respectively, of each of the microreactor; a temperature sensor that detects the temperature in the microreactor; and a pressure gage installed at the outlet side of the pump. The chemical synthesis device controls, in connection with values detected by the temperature sensor and the pressure gage, the opening and closing of the inlet solenoid valve and the outlet solenoid valve as well as a rate of flow from the pump.

### CLAIM OF PRIORITY

The present application claims priority from Japanese application JP2006-266252 filed on Sep. 29, 2006, the content of which is hereby incorporated by reference into this application.

### BACKGROUND OF THE INVENTION

1. Field of the Invention

The present invention relates to a chemical synthesis device for causing a chemical reaction of two fluids in a microchannel on the order of several tens of micrometers to several hundreds of micrometers, and is particularly suitable for a chemical synthesis device including a parallel arrangement of microchannels to increase the volume of production.

2. Description of the Related Art

A microdevice for chemical reaction is called a microreactor, the features of which include (1) high heating and cooling rates, (2) a laminar flow, (3) a large surface area per unit volume, (4) quickly proceeding reaction because of a short diffusion length of a substance, and the like. A micro reaction field can possibly have an essential influence on chemical reaction itself.

Moreover, enormous amounts of time and effort have heretofore been required for a transfer from synthesis in a laboratory to industrial production, since the making and inspection of a pilot plant are indispensable for a scale-up.

Furthermore, chemical reaction in the micro reaction field involves monitoring a reaction temperature, a pressure, a flow rate and the amount of reaction products for each microreactor, and feeding back the measured values, in order to achieve chemical reaction with higher efficiency by precisely controlling a temperature and a reaction time which is known as disclosed, for example, in Japanese Patent Application Laid-open Publication No. 2006-145516.

### SUMMARY OF THE INVENTION

In a parallel microreactor plant for safe and continuous synthesis of a given amount of products for commercial production for a long duration, a change in a flow rate or the like caused by the occurrence of abnormal conditions in channels in one or some microreactors can possibly change reaction conditions for the other microreactors change. Moreover, reaction products in a microreactor in which an abnormal condition is encountered can possibly be different in composition or the like from reaction products under normal conditions.

Furthermore, a parallel microreactor device including a parallel arrangement of many microreactors, and detecting abnormal conditions by merely monitoring the pressure or the flow rate for each microchannel as is the case with the conventional art is incapable of actual production, and causes, in particular, a rise in production costs. For example, a sensor for monitoring the pressure or the flow rate is inevitably costly, since there are demands that the sensor be of high corrosion resistance and heat resistance because of the use of diverse chemical substances for reaction and the presence of various reaction temperatures, and that the sensor achieves high accuracy in detecting a tiny change in the pressure or the flow rate.

Furthermore, it is necessary to detect not only abnormal conditions caused by the change in the pressure or the flow rate, but also abnormal conditions that do not involve the change in the pressure or the flow rate, such as a decrease in a reaction rate and runaway reaction.

An object of the present invention is to solve the foregoing problems inherent in the conventional art, to increase the volume of production even with the use of a microreactor, to achieve an efficient transfer and scale-up from research and development to industrial production, and to improve the quality of reaction products. Another object of the present invention is to quickly locate an abnormal condition at the occurrence of the abnormal condition, thereby making it possible to lessen the influence of the abnormal condition on the volume of production or the like and restore a normal condition.

Still another object of the present invention is to facilitate maintenance, and thereby, to reduce maintenance costs, regardless of an increase in the volume of production.

Incidentally, the present invention is intended to achieve at least one of the above objects.

To achieve the above objects, the present invention provides a chemical synthesis device including a microreactor having a microchannel that mixes at least two fluids, and a tank that collects a liquid mixed in the microreactor, which includes: plural microreactors arranged in parallel; a raw material tank that stores a raw material to be introduced into the microreactor; a pump that delivers the raw material; an inlet solenoid valve and an outlet solenoid valve disposed at the inlet and outlet sides, respectively, of the microreactor; a temperature sensor that detects the temperature in the microreactor; and a pressure gage installed at the outlet side of the pump, wherein the opening and closing of the inlet solenoid valve and the outlet solenoid valve as well as a rate of flow from the pump are controlled in connection with values detected by the temperature sensor and the pressure gage.

According to the present invention, the solenoid valves are disposed at the inlet and outlet sides of the microreactor, and the opening and closing of the solenoid valves as well as the flow rate are controlled in connection with the temperature and the pressure. Thereby, the present invention enables increasing the volume of production with the use of a microreactor and improving the quality of reaction products. Moreover, the present invention enables lessening the influence of the occurrence of an abnormal condition upon the volume of production or the like and restoring a normal condition, and enables facilitating maintenance regardless of an increase in the volume of production.

### BRIEF DESCRIPTION OF THE DRAWINGS

FIGS. 1A and 1B are a block diagram showing a temperature sensor unit according to one embodiment of the present invention, and a block diagram showing a parallel arrangement of plural microreactors according to the embodiment of the present invention, respectively.

FIGS. 2A and 2B are a graph showing a change in temperature in the microreactor according to the embodiment under normal conditions, and a graph showing a change in temperature in the microreactor according to the embodiment at the occurrence of an abnormal condition, respectively.

FIG. 3 is a block diagram showing a system according to another embodiment of the present invention.

FIG. 4 is a block diagram showing a system according to still another embodiment of the present invention.

FIGS. 5A, 5B and 5C are a graph showing a flow rate in a block in which an abnormal condition is not encountered, a graph showing a flow rate in a block containing a microreactor in which an abnormal condition is encountered, and a graph showing a flow rate in an abnormal condition detecting channel, respectively.

FIG. 6 is a flowchart showing a control algorithm at the occurrence of an abnormal condition.

### DETAILED DESCRIPTION OF THE PREFERRED EMBODIMENTS

Description will be given below with regard to one embodiment of the present invention with reference to the accompanying drawings.

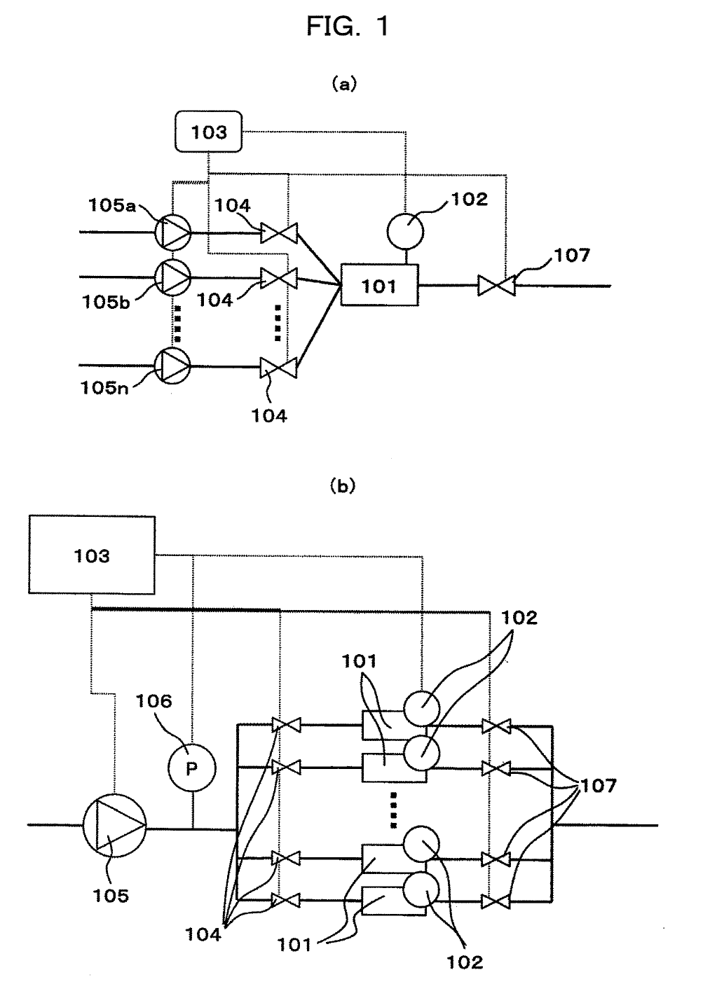

FIG. 1A shows, in conceptual illustration, a channel including a microreactor including a temperature monitoring device and a flow rate regulating mechanism. In the microreactor, n types of solutions are mixed. A temperature sensor 102 is installed in an internal channel mixer of a microreactor 101 to monitor a channel temperature in the microreactor 101 in real time, and to feed the measured value to a control system 103. The control system 103 controls the opening and closing of an inlet solenoid valve 104 and an outlet solenoid valve 107 as well as the rates of flows from pumps for delivering source solutions into the microreactor 101, namely, a pump 105a for a raw material a to a pump 105n for a raw material n, according to the measured channel temperature.

FIG. 1B shows, in conceptual illustration, a parallel arrangement of plural systems each shown in FIG. 1A. A channel for one of the n types of source solutions alone is shown in terms of the source solution part in FIG. 1B. The pump 105 provides delivery of the solution to all the plural parallel-arranged microreactors 101. The temperature sensors 102 installed in the channel mixers within the microreactors 101 provide sequential individual feeding of the channel temperatures in the microreactors to the control system 103. The control system 103 controls the opening and closing of the inlet solenoid valves 104 and the outlet solenoid valves 107 as well as the rate of flow from the pump 105 for delivering the source solution into the reactors, according to the measured channel temperatures.

Description will be given with regard to a method for detecting an abnormal condition due to a change in temperature at the occurrence of exothermic reaction, with reference to graphs showing how the temperature varies with time in the system shown in FIGS. 1A and 1B under normal conditions and under abnormal conditions.

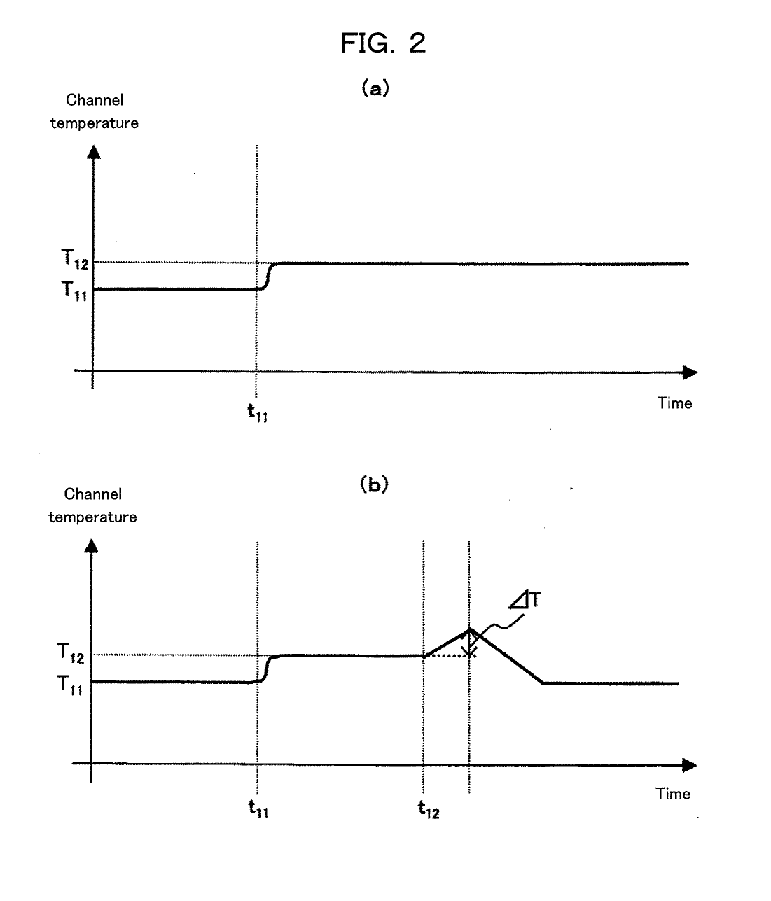

FIG. 2A shows a time-varying temperature in the vicinity of the reactor under normal operating conditions, and the channel temperature is a pre-reaction channel temperature T₁₁, until reaction start time t₁₁. After the start of reaction after the reaction start time t₁₁, the channel temperature rises to a normal reaction temperature T₁₂, which is then held constant. This temperature is held constant until the completion of the reaction, that is, until the completion of operation of the pump 105.

FIG. 2B shows a time-varying temperature in the vicinity of the reactor in which an abnormal condition is encountered in the channel during operation, and the behavior of temperature is the same as shown in FIG. 2A until occurrence-of-abnormality time t₁₂. When the abnormal condition is encountered in the channel at the occurrence-of-abnormality time t₁₂, the channel temperature rises, for example, in the event of runaway reaction, resulting in a temperature deviation ΔT from the normal reaction temperature T₁₂.

The channel temperature is measured by the temperature sensor 102, and the measured value is fed to the control system 103. Thereby, the control system 103 detects the temperature deviation ΔT from the normal reaction temperature T₁₂ due to the abnormal condition encountered in the channel, and closes the inlet solenoid valves 104 preceding and following the microreactor having the temperature deviation, thereby preventing a fluid in the microreactor in which the abnormal condition is encountered from joining fluids in other microreactors.

In a case where the pump 105 keeps on delivering the source solution at a fixed flow rate at all times, the closing of the channel in which an abnormal condition is encountered leads to an increase in the flow rate of the source solution flowing into other microreactors. Thus, the control system 103 detects a change in the flow rate involved in the closing of the channel according to a pressure value fed from a pressure gage 106 for entire channel monitoring, which is installed as, at once, following the pump 105 and preceding a branch point of the channel. The control system 103 then changes the rate of flow from the pump 105 so that the flow rate is equal to that before the change. This enables keeping constant the flow rate of flowing into other microreactors. Alternatively, the control system 103 may control the flow rate so that the flow rate is proportional to the number of microreactors 101 in operation.

Moreover, the reaction temperature has an error of the order of 0.1 to 0.2 degrees since the microreactor is a fine channel. Desirably, hence, the control system 103 judges as the abnormal condition a condition where the temperature deviation ΔT from the normal reaction temperature T₁₂ is equal to, or greater than, 0.1 to 0.2 degrees. This enables quick detection and handling of the abnormal condition, such as issuing a warning in the event of the temperature deviation ΔT equal to, or greater than, 0.1 degrees.

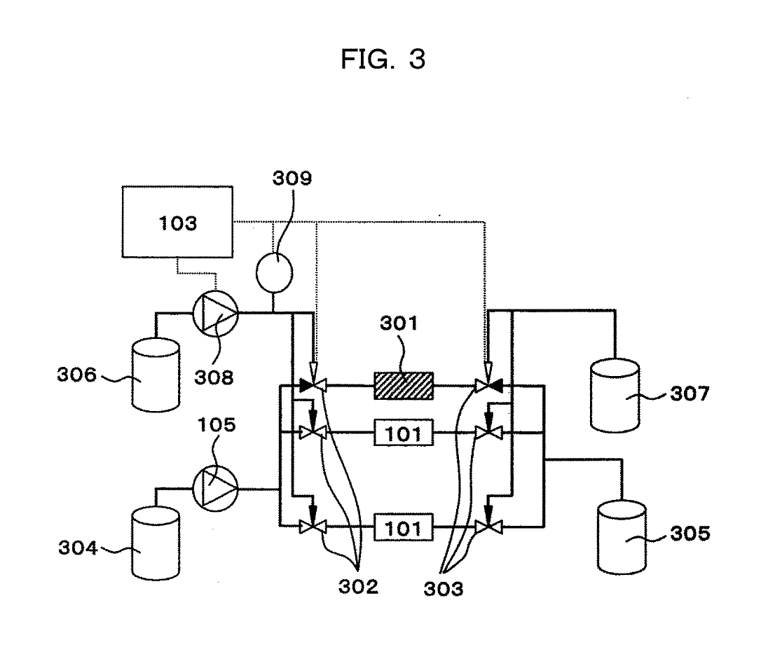

FIG. 3 shows a system including a channel containing a microreactor in which an abnormal condition is encountered, and cleaning channels installed in channels preceding and following each microreactor. An inlet three-way solenoid valve 302 and an outlet three-way solenoid valve 303 are disposed in the channels preceding and following the microreactor 101, respectively, and the valves 302 and 303 each have a connection to the cleaning channel.

Description will be given with regard to a method for cleaning a microreactor in which an abnormal condition is encountered, and a method for reconnecting a microreactor to an original channel.

An abnormally-conditioned reactor 301 in which an abnormal condition is encountered (hereinafter, simply termed as an “abnormally-conditioned” reactor) is linked to the cleaning channels by means of operating the inlet three-way solenoid valve 302 and the outlet three-way solenoid valve 303 by the control system 103. The inlet cleaning channel is connected to a cleaning solution tank 306, a cleaning solution pump 308, and a cleaning channel sensor 309, and the outlet cleaning channel is connected to a waste tank 307. Desirably, a pressure gage or a flowmeter is used as the cleaning channel sensor 309.

After doing switching to connect the channels preceding and following the abnormally-conditioned reactor 301 to the cleaning channels, the control system 103 brings the cleaning solution pump 308 into operation so that the pump 308 provides delivery of a cleaning solution at a fixed flow rate or pressure. Desirably, the cleaning solution for delivery is a solvent having a high affinity for, or high solubility in, a substance dissolved in the source solution, since the abnormal channel condition can possibly result from deposition of the raw material on a channel wall.

During the delivery of the solution, the cleaning channel sensor 309 monitors the pressure or flow rate in the channel at all times, and outputs the measured value to the control system 103. When the channel is in normal condition, the rate of flow from the cleaning solution pump 308 or the pressure therein is preset so that the pressure or the flow rate has a given fixed value.

When, after the delivery of the solution for a given period of time, the pressure or the flow rate monitored by the cleaning channel sensor 309 is equal to the pressure or the flow rate under normal channel conditions, the control system 103 judges the abnormally-conditioned reactor 301 as having gone out of the abnormal condition, and does switching of the inlet three-way solenoid valve 302 for the abnormally-conditioned reactor 301, thereby providing a connection to the source solution side to admit the source solution.

After the passage of the source solution for a period of time for the source solution to replace the cleaning solution remaining in the internal channel of the abnormally-conditioned reactor 301 and the channels preceding and following the reactor 301, the control system 103 does switching of the outlet three-way solenoid valve 303 for the abnormally-conditioned reactor 301, thereby providing a connection to the product solution side. Consequently, the solution flowing through the abnormally-conditioned reactor 301 flows again into a product tank.

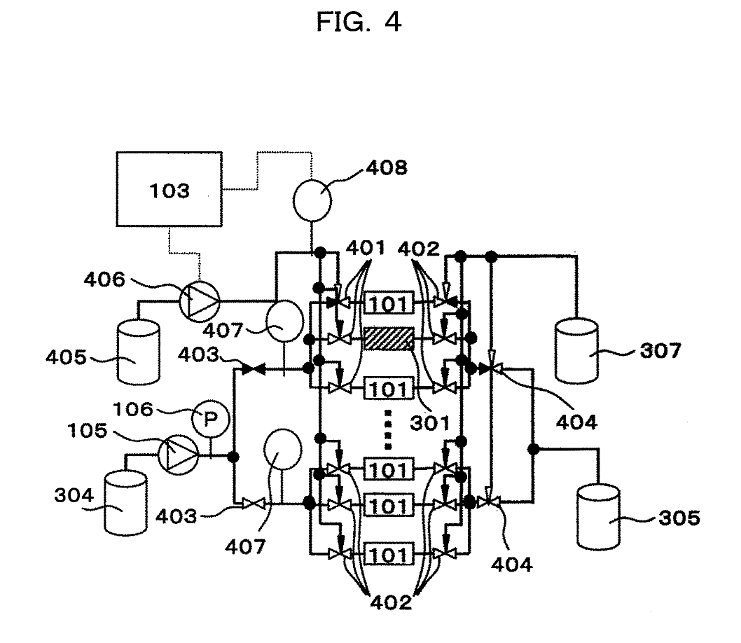

Description will now be given with reference to FIG. 4 with regard to a system configured as given below. The channels preceding the microreactors are joined, and the channels following the microreactors are also joined. Thereby, the microreactors are formed into a block. An abnormal condition detecting sensor is installed for either one of the channels preceding and following the block. Another channel is installed for use in the location of abnormal conditions and is provided therein with a pressure gage or a flowmeter.

Each block is formed by joining several preceding and following channels, as one unit, including the microreactors 101, inlet three-way solenoid valves 401 and outlet three-way solenoid valves 402. A preceding block channel solenoid valve 403 is installed in the channel preceding the block, and an abnormal condition detecting sensor 407 is installed in either one of the channels preceding and following the block. A flowmeter, a pressure gage, a thermometer, an absorptiometer or the like is suitable for use as the abnormal condition detecting sensor 407.

The installed position of the abnormal condition detecting sensor 407 can be set for accurate detection of an abnormal condition encountered in the microreactor 101, as given below. When the pressure gage is used as the abnormal condition detecting sensor 407, the sensor 407 is installed in the preceding block of the channels. When the thermometer or the absorptiometer is used as the abnormal condition detecting sensor 407, the sensor 407 is installed in the channel following the block. When the flowmeter is used as the abnormal condition detecting sensor 407, the sensor 407 can be installed in either of the channels preceding and following the block, because a change in the flow rate caused by the abnormal condition encountered in the microreactor 101 is detectable with either of the channels preceding and following the block.

The abnormal condition detecting sensor 407 monitors the state of the channels at any time, and outputs the measured values to the control system 103. The control system 103 controls the opening and closing of the preceding block channel solenoid valve 403 and the rate of flow from the pump 105 according to the measured values. An abnormal condition detecting channel, aside from source solution and product solution channels, is connected to the inlet three-way solenoid valve 401 and the outlet three-way solenoid valve 402.

When the narrowing or clogging of the channel occurs in the abnormally-conditioned reactor 301, a change in the flow rate or the pressure occurs throughout the entire block containing the reactor 301. The change in the flow rate or the pressure is monitored by the abnormal condition detecting sensor 407, which in turn feeds the measured value to the control system 103. Then, the control system 103 closes the preceding block channel solenoid valve 403 for the block containing the abnormally-conditioned reactor 301, incident to the change in the pressure or the flow rate. At the same time, the control system 103 connects the following channels to the waste tank 307 by operating a following block three-way solenoid valve 404 present following the block containing the abnormally-conditioned reactor 301.

At the same time, further, the control system 103 causes an abnormal channel locating pump 406 to start operating, and drives the inlet three-way solenoid valve 401 and the outlet three-way solenoid valve 402 for one of the microreactors 101 in the block containing the abnormally-conditioned reactor 301 to thereby connect the microreactor 101 to the abnormal condition locating channel.

The abnormal channel locating pump 406 starts operating to deliver a solution from an abnormal channel locating solution tank 405 into the microreactor 101, and the pressure in the channel is monitored by an abnormal channel locating sensor 408, which in turn feeds the measured value to the control system. A pressure gage or a flowmeter is used as the abnormal channel locating sensor 408.

When the channel containing the microreactor 101 connected to the abnormal channel locating channel is in normal condition, the rate of flow from the abnormal channel locating pump 406 or the pressure therein is preset so that the pressure or the flow rate monitored by the abnormal channel locating sensor 408 has a given fixed value. Thus, when the pressure or the flow rate monitored by the abnormal channel locating sensor 408 is equal to the preset value, the control system 103 judges the channel as being in normal condition and then disconnects the microreactor 101 from the abnormal condition locating channel by driving the inlet three-way solenoid valve 401 and the outlet three-way solenoid valve 402 preceding and following the channel, respectively.

At the same time, the control system 103 provides a connection to the abnormal condition locating channel by operating the inlet three-way solenoid valve 401 and the outlet three-way solenoid valve 402 preceding and following another microreactor 101 in the abnormal block, and repeats the same operation. When the abnormal condition locating channel is connected to the abnormally-conditioned reactor 301 by repeating this operation, the abnormal channel locating sensor 408 indicates a different value from the value which the sensor 408 indicates when connected to a normal channel. Thus, the control system 103 judges the abnormally-conditioned reactor 301 as being in abnormal condition. The control system 103 then opens the preceding block channel solenoid valve 403 for the block containing the abnormally-conditioned reactor 301, while keeping the channels preceding and following the abnormally-conditioned reactor 301, connected to the abnormal condition locating channel, to thereby admit the source solution. The following block three-way solenoid valve 404 for the block containing the abnormally-conditioned reactor 301 is kept connected to the waste tank 307. Thereby, the source solution passes through the microreactors 101 present in the abnormal block, except for the abnormally-conditioned reactor 301, and the source solution also flows into the waste tank 307. Thereby, the source solution forces away an abnormal channel locating solution, an old source solution or product solution present in the microreactors 101. After the passage of the source solution having greater volume than necessary to force away the solution, the control system 103 provides a connection to the channel leading to a product solution tank 305 by operating the following block three-way solenoid valve 404 for the block containing the abnormally-conditioned reactor 301, so that the reactors other than the abnormally-conditioned reactor 301 are reconnected to the original channels.

When the pump 105 keeps on delivering the source solution at a fixed flow rate at all times, the closing of the block in which an abnormal condition is encountered leads to an increase in the flow rate of flowing into other microreactors. When, after the location of the abnormally-conditioned reactor 301, the source solution is allowed to flow into the block containing the abnormally-conditioned reactor 301, this leads to a decrease in the flow rate of flowing into other microreactors. Thus, the control system 103 recognizes a change in the pressure involved in the closing or opening of the channel through the pressure value fed from the pressure gage 106 for entire channel monitoring, which is installed as, at once, following the pump 105 and preceding the branch point of the channel. The control system 103 then changes the rate of flow from the pump 105 so that the pressure is equal to that before the change. This enables keeping constant the flow rate of flowing into other microreactors. At this point, the control system 103 may adopt a simple flow rate control method that involves controlling the flow rate so that the flow rate is proportional to the number of microreactors 101 in operation. The system shown in FIG. 4 eliminates the need for the additional provision of the cleaning solution channel shown in FIG. 3, and the abnormal channel locating channel and tank can also serve as the cleaning solution channel and tank, respectively.

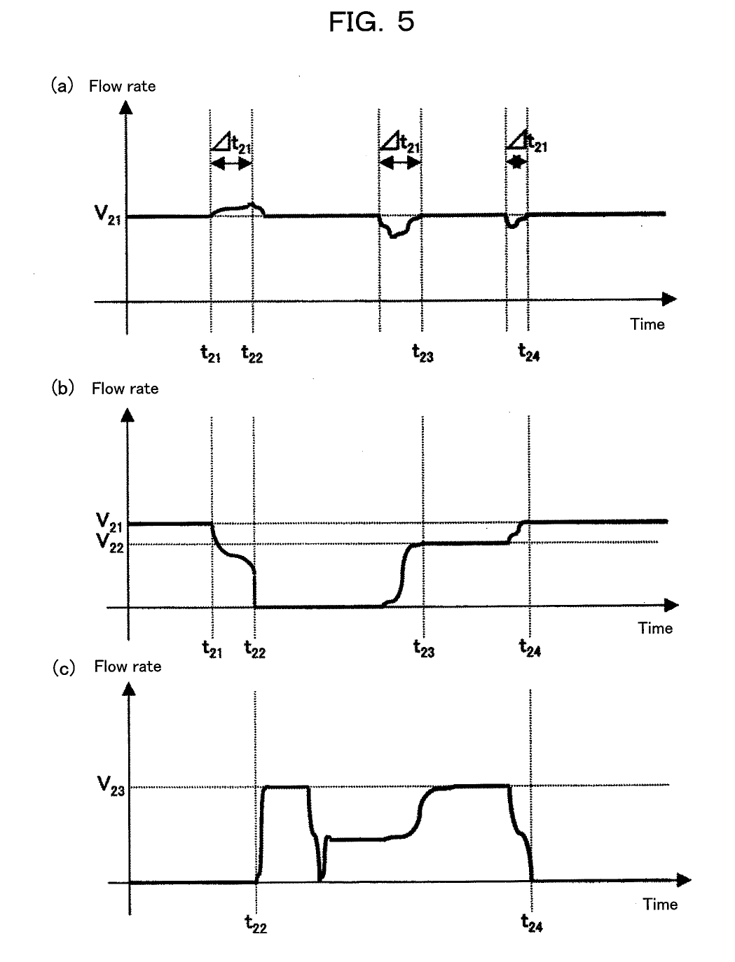

FIGS. 5A to 5C show a change in the flow rate in each block and cleaning channel, where the narrowing of a channel occurs in a microreactor plant in which an abnormal condition detecting system based on a block of channels and an abnormal condition detecting channel also serve as a cleaning channel. The flow rate in every block is a flow rate V₂₁ under normal operating conditions, until an abnormal condition is encountered in a channel at occurrence-of-abnormality time t₂₁,. When the abnormal condition is encountered in the channel at the occurrence-of-abnormality time t₂₁, the flow rate in a block containing a reactor in which the abnormal condition is encountered, as shown in FIG. 5B, decreases due to the occurrence of the narrowing of the channel in the reactor in which the abnormal condition is encountered.

A change in the flow rate is detected by the abnormal condition detecting sensor 407, which in turn outputs the detected value to the control system 103. Thereby, the control system 103 recognizes the abnormal block. At abnormal condition detection time t₂₂, the control system 103 then closes the preceding block channel solenoid valve 403 for the abnormal block to thereby close the abnormal block. At this time, the source solution does not flow into the abnormal block and thus the flow rate therein becomes zero, whereas the flow rate in the rest, namely, normal blocks, increases temporarily as shown in FIG. 5A. Thus, there is provided the pressure gage 106 for entire channel monitoring, which is installed as, at once, following the pump 105 and preceding the branch point of the channel. The control system 103 recognizes the change in the pressure through the pressure value from the pressure gage 106. The control system 103 then changes the rate of flow from the pump 105 so that the pressure is equal to that before the change. This enables keeping constant the flow rate of flowing into other microreactors.

After the closing of the abnormal block, the control system 103 also provides a connection to the abnormal condition detecting channel by driving the inlet three-way solenoid valve 401 and the outlet three-way solenoid valve 402 for one of the microreactors 101 in the abnormal block. Incidentally, the abnormal condition detecting channel also serves as the cleaning channel. After providing the connection to the abnormal condition detecting channel, the control system operates the abnormal channel locating pump 406 so that the solution flows into the microreactor 101 connected to the abnormal condition detecting channel.

When the channel containing the microreactor 101 connected to the abnormal condition detecting channel is in normal condition, the rate of flow from the abnormal channel locating pump 406 or the pressure therein is preset so that the pressure or the flow rate monitored by the abnormal channel locating sensor 408 has a given fixed value. Thus, when the rate of flow from the abnormal channel locating pump 406 or the pressure therein is equal to the preset value, the channel containing the microreactor 101 is in normal condition, and the flow rate in the abnormal condition detecting channel, as shown in FIG. 5C, is a flow rate V₂₃ of a case where the passage of the solution is through the normal channel. In short, at this time, the control system 103 recognizes the channel as being in normal condition, and then disconnects the microreactor 101 from the abnormal condition locating channel by operating the inlet three-way solenoid valve 401 and the outlet three-way solenoid valve 402 preceding and following the channel, respectively.

Then, the control system 103 provides a connection to the abnormal condition locating channel by operating the inlet three-way solenoid valve 401 and the outlet three-way solenoid valve 402 for another microreactor 101 in the abnormal block, and repeats the same operation.

When an abnormal condition is encountered in the channel in the microreactor 101 connected to the abnormal condition locating channel, the flow rate detected by the abnormal channel locating sensor 408 is lower than the flow rate V₂₃ during the passage of the solution through the normal channel. At this time, the control system 103 judges the microreactor 101 as being in abnormal condition. The control system 103 then opens the preceding block channel solenoid valve 403 for the block containing the microreactor 101 judged as being in abnormal condition, while keeping the channels preceding and following the microreactor 101 judged as being in abnormal condition, connected to the abnormal condition locating channel.

The following block three-way solenoid valve 404 for the block containing the microreactor 101 judged as being in abnormal condition remains connected to the waste tank 307. Thereby, the source solution passes through the microreactors 101 present in the abnormal block, except for the microreactor 101 judged as being in abnormal condition, and the source solution also flows into the waste tank 307. Thus, the source solution can force away the abnormal channel locating solution, old source solution or product solution present in the normal microreactors 101 in the abnormal block. After the passage of the source solution having greater volume than necessary to force away the solution, the control system 103 further provides a connection to the channel leading to the product solution tank 305 by operating the following block three-way solenoid valve 404 for the block containing the abnormally-conditioned reactor 301, thereby reconnecting the reactors other than the abnormally-conditioned reactor 301 to the original channels.

By a series of operations mentioned above, the flow rate rises in order that the source solution again passes through the block containing the reactor in which the abnormal condition is encountered. In a case where each block is formed of a block of N microreactors 101, the value of the flow rate, at abnormal block recovery time t₂₃, reaches a flow rate V₂₂ in the block containing the abnormal reactor, which is (N-1/N) times of the flow rate V₂₁ under normal operating conditions, because of the disconnection of the abnormal reactor.

The abnormal condition detecting channel, as having a connection to the microreactor 101 in which the abnormal condition is encountered, keeps on receiving delivery of the solution, and thus the flow rate in the abnormal condition detecting channel increases gradually by the cleaning effect of the solution passing through the abnormal condition detecting channel. When, after that, the flow rate detected by the abnormal channel locating sensor 408 is equal to the flow rate V₂₃ of the passage of the solution through the normal channel, the control system 103 judges the abnormally-conditioned microreactor 101 as having gone out of abnormal condition, and does switching of the inlet three-way solenoid valve 401 for the abnormally-conditioned microreactor 101, thereby providing a connection to the source solution side to admit the source solution.

After the passage of the source solution for a period of time for the source solution to replace the cleaning solution remaining in the internal channel of the microreactor 101 judged as being in abnormal condition and the channels preceding and following the microreactor 101, the control system 103 does switching of the outlet three-way solenoid valve 402 for the microreactor 101 judged as being in abnormal condition, thereby providing a connection to the product solution side. Thus, the solution flowing through the microreactor 101 judged as being in abnormal condition flows again into the product tank. Thereby, the number of reactors in operation in the block containing the reactor in which the abnormal condition is encountered is N, which is the same as the number of normal blocks. Thus, the flow rate in the block containing the abnormally-conditioned reactor, at abnormal reactor recovery time t₂₄, is the flow rate V₂₁ under normal operating conditions.

During a given period of time after the occurrence-of-abnormality time t₂₁, a given period of time until the abnormal block recovery time t₂₃, and a given period of time until the abnormal reactor recovery time t₂₄, abnormal flow rate time Δt₂₁ is present in the normal blocks and the block containing the abnormal reactor. This change in the flow rate can possibly have some influence on chemical reaction in the microreactors 101, resulting in a deterioration in the quality of the entire reaction product. Thus, the control system 103 gets rid of an affected reaction solution of the solutions flowing through the microreactors 101 within the abnormal flow rate time Δt₂₁ detected by the abnormal condition detecting sensor and recognized by the control system 103, by doing switching of the following block three-way solenoid valve 404 to provide a connection to the channel leading to the waste tank 307 for a given period of time.

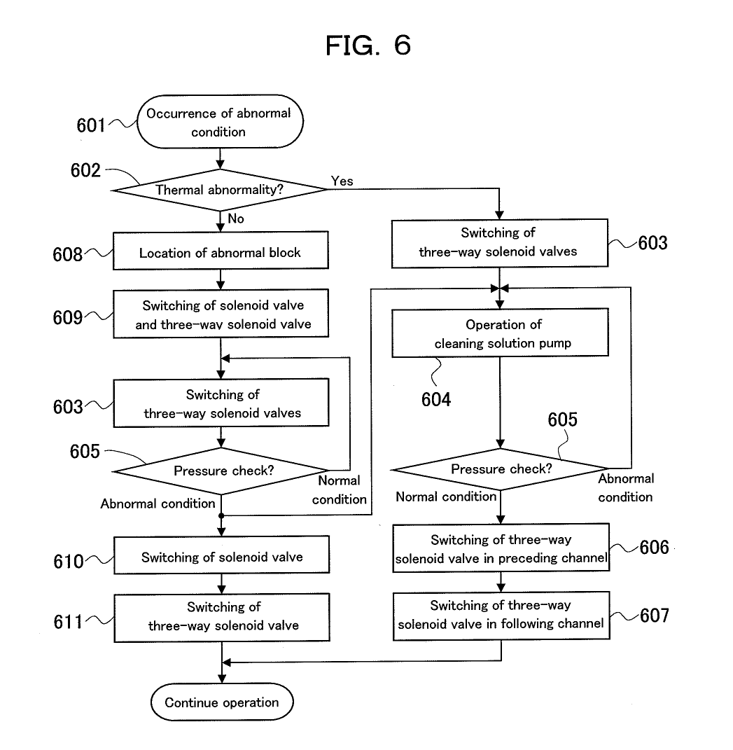

FIG. 6 shows a processing algorithm, where an abnormal condition is encountered in a channel in a microreactor plant including an abnormal condition detecting system based on a temperature sensor, an abnormal condition detecting system based on a block of channels, and a cleaning channel.

At the occurrence 601 of an abnormal condition in the microreactor, the abnormal condition is detected in the form of a change in temperature, a change in flow rate or a change in pressure by the temperature sensor 102 or the abnormal condition detecting sensor 407. The control system 103 determines the presence or absence of a thermal abnormality 602 after the occurrence of the abnormal condition, according to the change in the temperature, flow rate or pressure value monitored at all times. When the pressure gage 106 for entire channel monitoring detects a change in pressure in the channel immediately following the pump 105, the control system 103 controls the rate of flow from the pump 105 so as to keep the pressure in the overall system constant.

In a case where the control system 103 determines the presence of the thermal abnormality 602, the control system 103 does switching 603 of the three-way solenoid valves in the channels preceding and following the microreactor 101 judged as being in abnormal condition, thereby providing a connection to the cleaning channel. A change in the flow rate in each microreactor 101 caused by shutdown is corrected by the control system 103 and the entire channel monitoring pressure gage 106 regulating the rate of flow from the pump 105.

Then, the cleaning solution pump is brought into operation 604 to clean the abnormal channel. The cleaning channel sensor 309 installed in the cleaning channel provides sequential detection and output of the pressure or the flow rate to the control system 103. The control system 103 makes a check 605 of the pressure or the flow rate, according to the pressure value or flow rate value during the delivery of the solution through the normal channel. When the checked pressure or flow rate is different from the pressure or flow rate under normal conditions, cleaning is continued.

When the checked pressure or flow rate is equal to the pressure or flow rate under normal conditions, the control system 103 does switching 606 of the three-way solenoid valve in the channel preceding the microreactor 101 in which the abnormal condition is encountered, thereby providing a connection to the source solution channel. After the passage of the source solution for a period of time for the source solution to replace the cleaning solution remaining in the internal channel of the abnormally-conditioned microreactor 101 and the channels preceding and following the microreactor 101, the control system 103 does switching 607 of the three-way solenoid valve in the channel following the microreactor 101 in which the abnormal condition is encountered, thereby reconnecting to the general channel the microreactor 101 in which the abnormal condition is encountered.

A change in the flow rate in each microreactor 101 is corrected by the control system 103 and the entire channel monitoring pressure gage 106 regulating the rate of flow from the pump 105.

In a case where the control system 103 determines the absence of the thermal abnormality 602, the control system 103 operates the abnormal condition detecting sensor 407 for abnormal block location 608. The control system 103 simultaneously does the closing of the solenoid valve preceding the block judged as being in abnormal condition, and switching 609 of the three-way solenoid valve following the abnormal block. Thus, the following three-way solenoid valve is connected to the cleaning channel side. A change in the flow rate in each microreactor 101 is corrected by the control system 103 and the entire channel monitoring pressure gage 106 regulating the rate of flow from the pump 105.

The control system does switching of the three-way solenoid valves preceding and following the microreactor 101 in the abnormal block, thereby providing a connection to the cleaning channel. After that, the control system makes the check 605 of the pressure or the flow rate by the passage of the cleaning solution, as in the case of the occurrence of the thermal abnormality. When the microreactor 101 is in normal condition, the control system does switching of the three-way solenoid valves preceding and following another microreactor 101 in the abnormal block, thereby providing a connection to the cleaning channel. The control system then repeats the same check.

When the microreactor 101 is in abnormal condition, the control system keeps on cleaning the channel. Processing thereafter is the same as in the case of the detection of the thermal abnormality.

The control system does opening 610 of the solenoid valve in the channel preceding the abnormal block except for the microreactor in which the abnormal condition is encountered, thereby providing a connection to the source solution channel. After the passage of the source solution for a period of time for the source solution to replace the cleaning solution remaining in the internal channels of the abnormal block and the channels preceding and following the abnormal block, the control system does switching 611 of the three-way solenoid valve in the channel following the abnormal block, thereby reconnecting the abnormal block to the general channel. A change in the flow rate in each microreactor 101 is corrected by the control system 103 and the entire channel monitoring pressure gage 106 regulating the rate of flow from the pump 105.

During a series of processes mentioned above, the normal microreactors 101 and the general channels containing the normal microreactors 101 keep on operating in the same manner as operation before the occurrence of the abnormal condition.

In a case where cleaning operation fails to make the pressure value normal, the following may be performed. When the abnormal condition can possibly result from deposition of the raw material or product substance within the channel, a heater (not shown) or the like, for example, may be used to selectively heat the microreactor 101 and thereby urge dissolution of the raw material or product substance. When the abnormal condition cannot be eliminated, operation is continued except for the abnormal channel.

As described above, in a parallel microreactor plant for safe and continuous synthesis of a given amount of products for commercial production for a long duration, the temperature sensor is disposed in a microchannel to detect abnormal conditions. Thereby, the present invention enables low-cost and quick detection of abnormal conditions, as compared to a conventional method. Moreover, the present invention enables quick and efficient detection of abnormal conditions that do not involve a change in pressure or flow rate.

Further, plural reactors are formed into a block, and the abnormal condition detecting sensor is used for each block. This enables a reduction in the number of abnormal condition detecting sensors for use, thus achieving a reduction in manufacturing costs for a microreactor system and a simplification of maintenance.

Further, only a microreactor in which an abnormal condition is encountered is cleaned and reconnected to a production channel. This enables preventing a significant decrease in the volume of production by the plant.

What is claimed is:

1. A chemical synthesis device including a microreactor having a microchannel that mixes at least two fluids, and a tank that collects a liquid mixed in the microreactor, comprising:
a plurality of aforementioned microreactors arranged in parallel;
a raw material tank that stores a raw material to be introduced into the microreactor;
a pump that delivers the raw material;
an inlet solenoid valve and an outlet solenoid valve disposed at the inlet and outlet sides, respectively, of the microreactor;
a temperature sensor that detects the temperature in the microreactors; and
a pressure gage installed at the outlet side of the pump,
wherein the opening and closing of the inlet solenoid valve and the outlet solenoid valve as well as a rate of flow from the pump are controlled in connection with values detected by the temperature sensor and the pressure gage.

2. The chemical synthesis device according to claim 1, wherein every two or more of the plurality of microreactors are formed into a block, and are connected in parallel with channels.

3. The chemical synthesis device according to claim 1, wherein an occurrence of an abnormal condition in the microreactor is detected according to the value detected by the temperature sensor, and the inlet solenoid valve connected to the detected microreactor is then closed.

4. The chemical synthesis device according to claim 1, wherein an occurrence of an abnormal condition in the microreactor is detected according to the value detected by the temperature sensor, the inlet solenoid valve connected to the detected microreactor is then closed, and the rate of flow from the pump is controlled so that a flow rate in the normal microreactor should have a predetermined value.

5. The chemical synthesis device according to claim 1, comprising:
an inlet three-way solenoid valve in place of the inlet solenoid valve;
an outlet three-way solenoid valve in place of the outlet solenoid valve;
a cleaning solution pump and a cleaning solution tank connected to the inlet three-way solenoid valve;
a waste solution tank connected to the outlet three-way solenoid valve; and
a cleaning channel sensor for measuring a pressure or a flow rate, which is disposed between the inlet three-way solenoid valve and the cleaning solution pump.

6. The chemical synthesis device according to claim 1, comprising:
a plurality of aforementioned microreactors, every two or more of which are formed into a block and are connected in parallel with channels;
an inlet three-way solenoid valve in place of the inlet solenoid valve;
an outlet three-way solenoid valve in place of the outlet solenoid valve;
an abnormal channel locating pump and an abnormal channel locating tank connected to the inlet three-way solenoid valve;
a waste tank connected to the outlet three-way solenoid valve;
an abnormal condition detecting sensor provided for each block; and
an abnormal channel locating sensor for measuring a pressure or a flow rate, which is disposed between the inlet three-way solenoid valve and the cleaning solution pump.

7. The chemical synthesis device according to claim 1, comprising:
a plurality of aforementioned microreactors, every two or more of which are formed into a block and are connected in parallel with channels;
an inlet three-way solenoid valve in place of the inlet solenoid valve;
an outlet three-way solenoid valve in place of the outlet solenoid valve; and
an abnormal condition detecting sensor that detects any one of a flow rate, a pressure, a temperature and an absorbance, for each block.
